(19) United States
(12) Patent Application Publication
(10) Pub. No.: US 2009/0171734 A1
(43) Pub. Date: Jul. 2, 2009

(54) SYSTEM AND METHOD FOR RESERVING SCHEDULING TIME

(76) Inventors: Sean Callanan, Churchtown (IE); Patrick Joseph O'Sullivan, Ballsbridge (IE); Gary Denner, Celbridge (IE); Carol Sue Zimmet, Boxborough, MA (US)

Correspondence Address: HOLLAND & KNIGHT, 10 ST. JAMES AVENUE, BOSTON, MA, 02116-3889, US

(21) Appl. No.: 11/967,351

(22) Filed: Dec. 31, 2007

(51) Int. Cl. G06Q 10/00

(52) U.S. Cl. 705/8

(57) ABSTRACT

A method and computer program product for reserving scheduling time includes defining a reserve time period in a scheduling system for a user. A reserve user group is defined including one or more reserve users, and the reserve user group is associated with the reserve time period. Scheduling permissions are assigned for the reserve time period based upon, at least in part, the associated reserve user group.

### TECHNICAL FIELD

This disclosure relates to scheduling and, more particularly, to systems and methods scheduling time periods reserved for use relative to a specified group of users.

### BACKGROUND

Calendar and scheduling applications provide a convenient mechanism for coordinating and scheduling meetings, appointments, events and the like with other individuals. Shared calendars further facilitate such coordination and scheduling. For example, using shared calendars, it is possible for one person to determine the availability of another for the purpose of scheduling meetings and appointments based. Rather than conducting a protracted exchange to determine a mutually agreeable time, scheduling invitations can be tailored to the known availability of desired attendees.

However, the ease and convenience with which meetings can be schedules can also result in a great time burden for the invitee in terms of managing each appointment individually, especially when it is also necessary to maintain availability for other required or desired tasks. For example, coworkers located in geographically separated regions face the challenge of coordinating common availability for meetings, teleconferences and the like across several time zones. Because of the time differences, the effective common time for the separated coworkers, during their respective business days, may be limited. The limited common time may make it difficult for the separated coworkers to schedule mutual appointments or meetings while managing requests from others who only have an awareness of the apparent availability.

### SUMMARY OF DISCLOSURE

In a first implementation, a method includes defining a reserve time period in a scheduling system for a user. The method also includes defining a reserve user group including one or more reserve users, and associating the reserve user group with the reserve time period. Scheduling permissions for the reserve time period are assigned based upon, at least in part, the associated reserve user group.

One or more of the following features may be included. Defining the reserve time period may include defining a recurring reserve time period. Defining the reserve user group may include defining one or more reserve users based upon, at least in part, an organizational structure. Further, defining one or more reserve users based upon, at least in part, an organizational structure may include defining one or more reserve users based upon, at least in part, an organizational hierarchy. Additionally/alternatively, defining the reserve user group may include defining one or more reserve users based upon, at least in part, a social network.

Assigning scheduling permissions may include restricting scheduling permissions for the reserve time period to the reserve user group. Further, assigning scheduling permissions may include restricting scheduling permissions of the reserve user group to the reserve time period. Additionally, assigning scheduling permissions may include restricting scheduling permissions of the reserve user group for the reserve time period.

The method may further include defining one or more exceptions to the assigned scheduling permissions. Defining one or more exceptions may include defining one or more exceptions based upon, at least in part, an organizational structure.

According to another implementation, a computer program product resides on a computer readable medium having a plurality of instructions stored thereon. When executed by a processor, the instructions cause the processor to perform operations including defining a reserve time period in a scheduling system for a user. A reserve user group is defined including one or more reserve users, and the reserve user group is associated with the reserve time period. Scheduling permissions for the reserve time period are assigned based upon, at least in part, the associated reserve user group.

One or more of the following features may be included. The instructions for defining the reserve time period may include instructions for defining a recurring reserve time period. Further, the instructions for defining the reserve user group may include instructions for defining one or more reserve users based upon, at least in part, an organizational structure. The instructions for defining one or more reserve users based upon, at least in part, an organizational structure, may include instructions for defining one or more reserve users based upon, at least in part, an organizational hierarchy. Additionally/alternatively, the instructions for defining the reserve user group may include instructions for identifying one or more reserve users based upon, at least in part, a social network.

The instructions for assigning scheduling permissions may include instructions for restricting scheduling permissions for the reserve time period to the reserve user group. Further, the instructions for assigning scheduling permissions may include instructions for restricting scheduling permissions of the reserve user group to the reserve time period. Additionally, the instructions for assigning scheduling permissions may include instructions for restricting scheduling permissions of the reserve user group for the reserve time period.

The computer program product may further include instructions for defining one or more exceptions to the assigned scheduling permissions. The instructions for defining one or more exceptions may include instructions for defining one or more exceptions based upon, at least in part, an organizational structure.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a reserve process and email application coupled to a distributed computing network.

FIG. 2 is a flowchart of a process executed by the reserve process of FIG. 1.

FIG. 3 diagrammatically depicts a calendar entry screen rendered by the reserve process and/or the email application of FIG. 1.

FIG. 4 diagrammatically depicts a calendar entry screen rendered by the reserve process and/or the email application of FIG. 1.

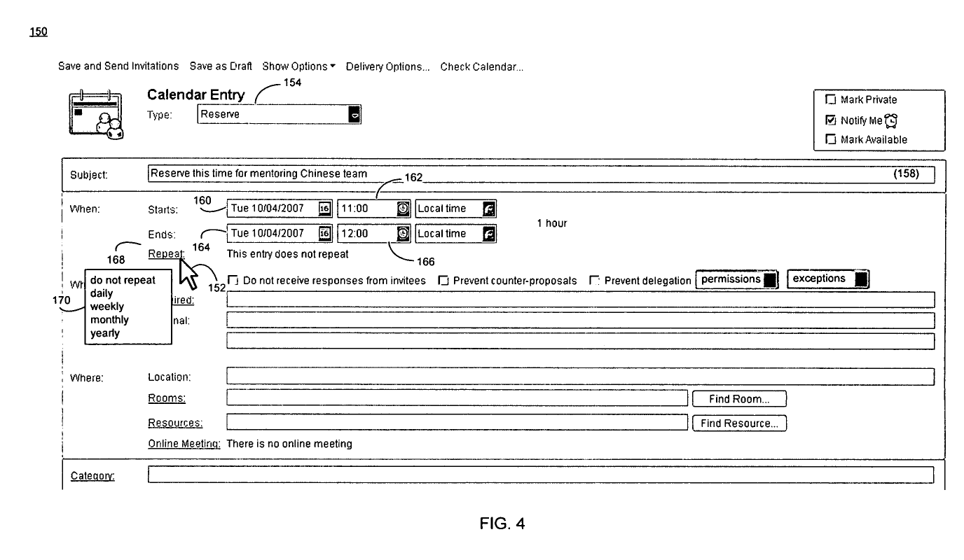

FIG. 5 diagrammatically depicts a calendar entry screen rendered by the reserve process and/or the email application of FIG. 1.

FIG. 6 diagrammatically depicts a calendar entry screen rendered by the reserve process and/or the email application of FIG. 1.

FIG. 7 diagrammatically depicts a calendar entry screen rendered by the reserve process and/or the email application of FIG. 1.

FIG. 8 diagrammatically depicts a calendar entry screen rendered by the reserve process and/or the email application of FIG. 1.

FIG. 9 diagrammatically depicts a calendar entry screen rendered by the reserve process and/or the email application of FIG. 1.

FIG. 10 diagrammatically depicts a display screen rendered by an email application of a reserve group user.

FIG. 11 diagrammatically depicts a display screen rendered by an email application of a non-reserve group user.

FIG. 12 diagrammatically depicts a display screen rendered by an email application of a reserve group user.

FIG. 13 diagrammatically depicts a display screen rendered by an email application of a reserve group user.

FIG. 14 diagrammatically depicts a calendar entry screen rendered by the reserve process and/or the email application of FIG. 1.

### DETAILED DESCRIPTION OF THE PREFERRED EMBODIMENTS

### System Overview:

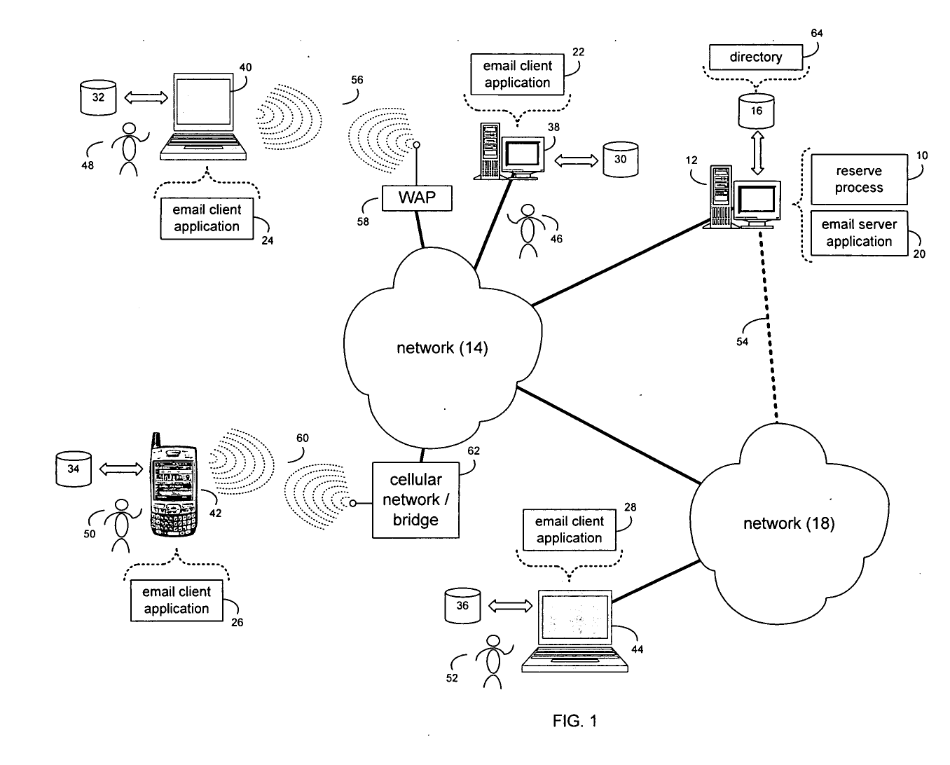

Referring to FIG. 1, there is shown reserve process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Alternatively, the reserve process may reside on and be executed, in whole or in part, by a client electronic device, such as a personal computer, notebook computer, personal digital assistant, or the like.

As will be discussed below in greater detail, reserve process 10 may allow a reserve time period to be defined in a scheduling system for a user. Additionally, reserve process 10 may allow a reserve user group, including one or more users, to be defined and to be associated with the reserve time period. Additionally, reserve process 10 may allow scheduling permissions for the reserve time period to be assigned based upon, at least in part, the associated reserve user group.

The instruction sets and subroutines of reserve process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute a calendar and/or scheduling application, e.g., which may be a module of email server application 20, examples of which may include but are not limited to Lotus Domino™ Server and Microsoft Exchange™ Server. Mail server application 20 may store and/or manage calendar and/or scheduling information and requests for one or more calendar and/or scheduling client applications, e.g., email client applications 22, 24, 26, 28, examples of which may include but are not limited to Lotus Notes™ and Microsoft Outlook™. Reserve process 10 may be a stand alone application that interfaces with email server application 20 or an applet/application that is executed within email server application 20.

The instruction sets and subroutines of email server application 20, which may be stored on storage device 16 coupled to server computer 12 may be executed by one or more processors (not shown) and one or more memory architectures (not shown) incorporated into server computer 12.

As mentioned above, in addition/as an alternative to being a server-side application residing on server computer 12, the reserve process may be a client-side application (not shown) residing on one or more client electronic device 38, 40, 42, 44 (e.g., stored on storage device 30, 32, 34, 36, respectively), and executed by one or more processors (not shown) and one or more memory architectures (not shown) incorporated into the one or more client electronic devices. The client-side reserve process may be a stand alone application that interfaces with a calendar/scheduling client application (e.g., email client applications 22, 24, 26, 28), or may be an applet/application that is executed within a calendar/scheduling client application. As such, the reserve process may be a client-side application, a server-side application, or a hybrid client-side/server-side application, which may be executed, in whole or in part, by server computer 12, and/or one or more of client electronic device (e.g., client electronic devices 38, 40, 42, 44).

The instruction sets and subroutines of email client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42. notebook computer 44, a data-enabled, cellular telephone (not shown), and a dedicated network device (not shown), for example. Using email client applications 22, 24, 26, 28, users 46, 48, 50, 52 may access email server application 20 and may retrieve and/or create scheduled events, such as meetings, appointments, and the like.

Users 46, 48, 50, 52 may access email server application 20 directly through the device on which the email client application (e.g., email client applications 22, 24, 26, 28) is executed, namely client electronic devices 38, 40, 42, 44, for example. Users 46, 48, 50, 52 may access email server application 20 directly through network 14 or through secondary network 18. Further, server computer 12 (i.e., the computer that executes email server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### The Reserve Process:

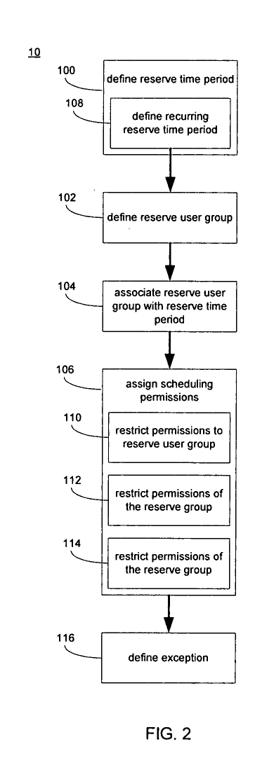

Referring also to FIG. 2, reserve process 10 may allow a user to define 100 a reserve time period in a scheduling system for the user. Additionally, reserve process 10 may allow the user to define 102 a reserve user group including one or more reserve users. Reserve process 10 may associate 104 the reserve user group with the reserve time period. Further, reserve process 10 may allow the user to assign 106 scheduling permissions for the reserve time period based upon, at least in part, the associated reserve user group.

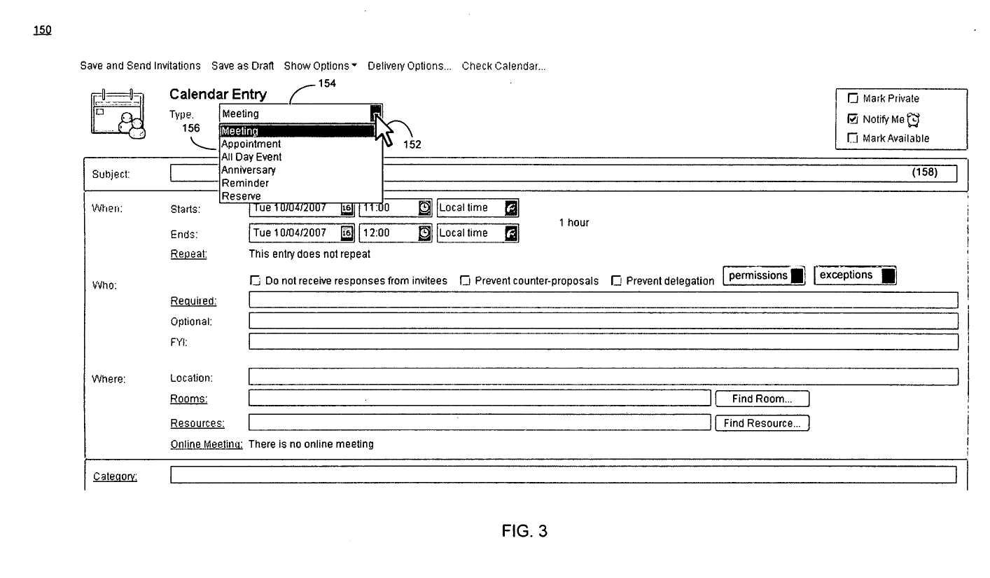

For example, and referring also to FIG. 3, reserve process 10 and/or email client application 22 may render calendar entry screen 150, via which user 46 may schedule meetings, appointments, events, and the like. User 46 may select, via onscreen pointer 152 controlled by a pointing device (e.g., a mouse; not shown), meeting type drop down 154, resulting in email client application rendering meeting menu 156. Meeting menu 156 may include available meeting type options including, but not limited to, “Meeting”, “Appointment”, “All Day Event”, “Anniversary”, “Reminder”, and “Reserve”. While meeting menu 156 is shown including only six options, this is for illustrative purposes only, as the number, and identity, of the options included within meeting menu 156 may be increased, decreased, and changed depending upon design criteria and user need.

Reserve process 10 may allow user 46 to define 100 a reserve time period by selecting, via onscreen pointer 152, “Reserve” in meeting menu 156. User 46 may provide a identifier for the reserve time period by inputting (e.g., using a keyboard; not shown) a description, for example “Reserve this time for mentoring Chinese team” in subject field 158. Additionally, reserve process 10 may further allow user 46 to define start and end times for the reserve time period (e.g., between 11 and 12 on Tuesday) using date and time drop down menus 160, 162, 164, and 166 and associated date and time menus (not shown) in a generally conventional fashion.

Reserve process 10 may allow the user to define the reserve timer period as a one-time event. Additionally/alternatively, defining 100 the reserve time period may include defining 108 a recurring reserve time period. For example, reserve process 10 may allow user 46 to define 108 the reserve time period “Reserve for mentoring Chinese team” as a recurring reserve time period. To define 108 a recurring reserve time period, user 46 may select, via onscreen pointer 152, “Repeat” option 168 in calendar entry screen 150. Selecting “Repeat” option 168 may result in reserve process 10 and/or email client application 22 rendering menu 170 including various repeat options, namely “do not repeat”, “daily”, “weekly”, “monthly”, and “yearly”. While menu 170 is only shown to include five options, this is for illustrative purposes only, as the number and identity of the options within menu 170 may be increased, decreased, and changed depending upon design criteria and user need. Continuing with the above-stated example, user 46 may select, via onscreen pointer 152, the option “weekly” in menu 170 to define 108 a weekly recurring reserve time period.

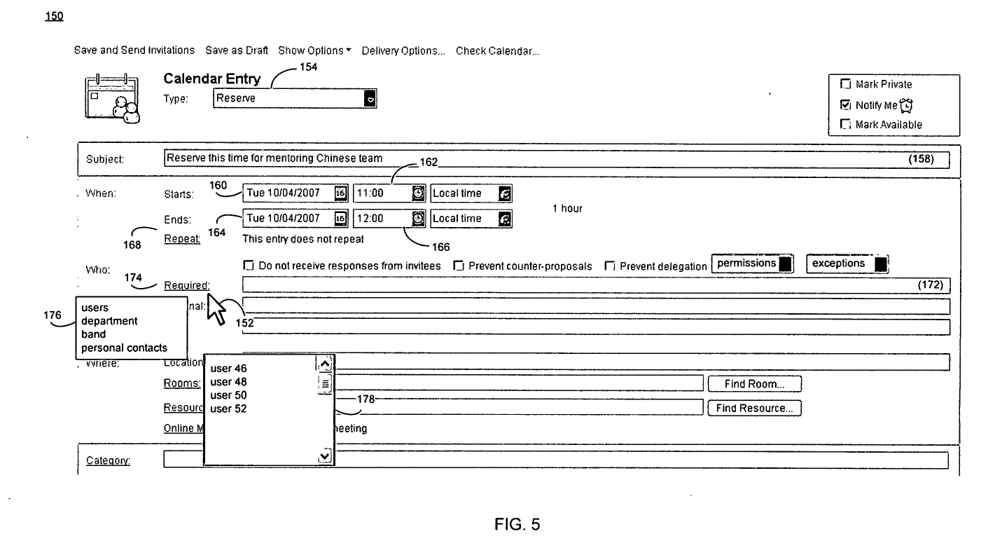

Reserve process 10 may allow user 46 to define 102 a reserve user group including one or more reserve users. Referring also to FIG. 5, user 46 may input, e.g., via a keyboard (not shown), the names of the one or more reserve users making up the reserve user group into “Required” field 172. Similarly, user 46 may input the one or more reserve users from, e.g., a contacts list, a corporate directory, or the like. For example, user 46 may select, via onscreen pointer 152, “Required” option 174. Selecting “Required” option 174 may result in reserve process 10 and/or email client application 22 rendering menu 176 including options “users”, “department”, “band”, and “personal contacts”. As with the various menus discussed herein, while menu 176 is shown including particular options, the illustrated and described options are for illustrative purposes only, as the number and identity of the options that may be included within menu 176 may vary according to design criteria and user need.

Continuing with the above-described example, user 46 may select, via onscreen pointer 152, “user” from menu 176, resulting in reserve process 10 and/or email client application 22 rendering user selection menu 178, which may include, for example, a list of users (namely, user 46, user 48, user 50, user 52) which may be populated from a corporate directory (e.g., directory 64 residing on server computer 12). Reserve process 10 may allow user 46 to define 102 the reserve user group by selecting, via onscreen pointer 152, one or more users from user selection menu 178.

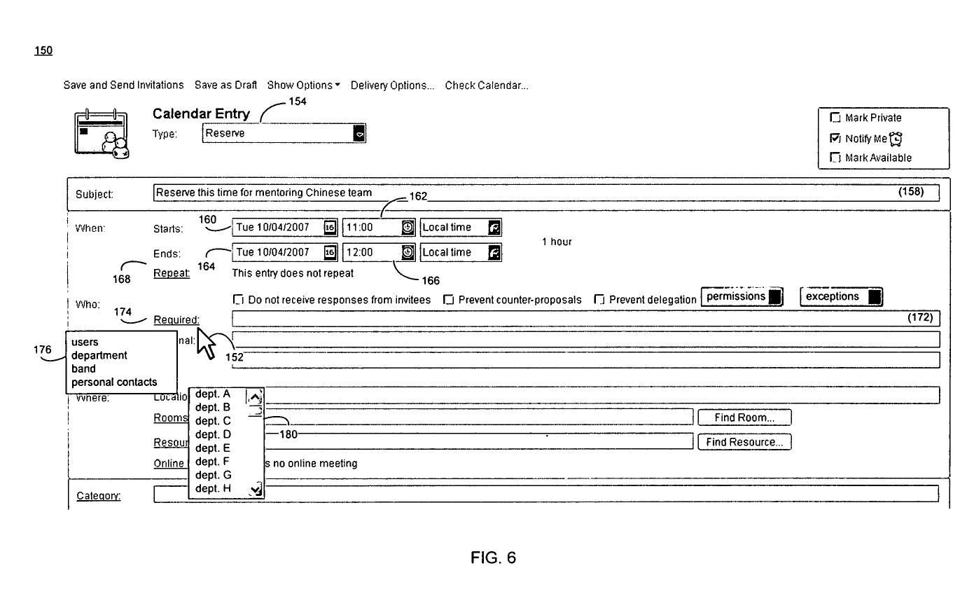

Additionally/alternatively, reserve process 10 may allow a user to define 100 the reserve user group including one or more reserve users based upon, at least in part, an organizational structure. The organizational structure may include users, departments, locations, hierarchal position (e.g., bands), and so forth. The organizational structure may be defined, for example, in a corporate directory (e.g., directory 64, residing on server computer 12). For example, and continuing with the previously described example, from menu 176 user 46 may select “department”. Referring also to FIG. 6, selecting “department” from menu 176 may result in reserve process 10 and/or email client application 22 rendering department menu 180, including, for example, “dept. A”, “dept. B”, “dept. C”, “dept. D”, “dept. E”, “dept. F”, “dept. G”, and “dept. H”, which may correspond to departments defined within directory 64, including the members of each of the departments. User 46 may select a desired department from within department menu 180, thereby defining 102 the reserve user group including the users within the selected department. As the reserve user group is defined 102 based upon, at least in part, an organizational structure (e.g., which may be defined within directory 64) not only is it unnecessary for user 46 list every user in the department, but additionally the selection of the department may provide a dynamic list of the users within the selected department, which may automatically be updated as users within the department change.

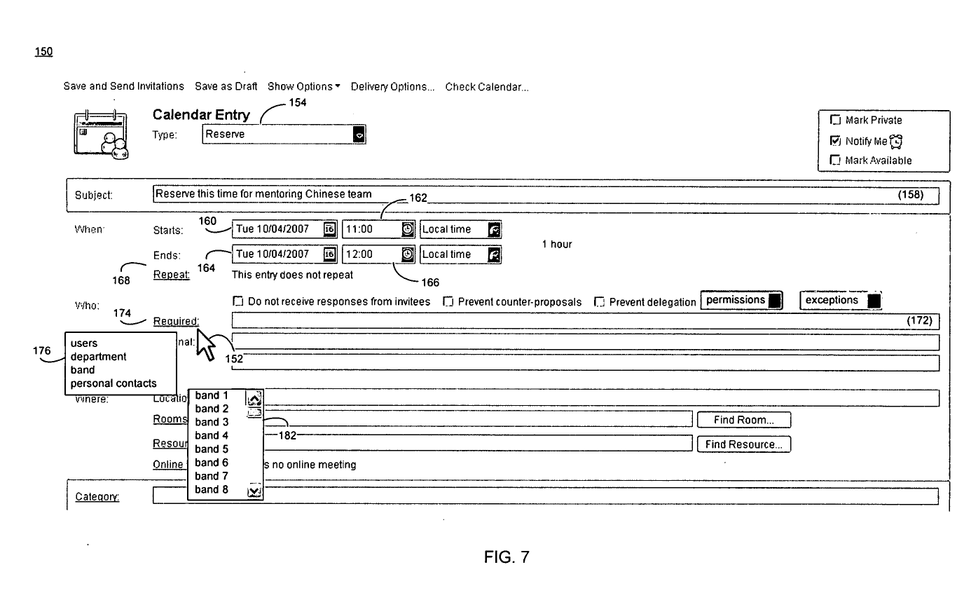

Still further, reserve process 10 may allow the user to define 102 reserve user group including one or more reserve users based upon, at least in part, an organizational hierarchy. Referring also to FIG. 7, similar to the above-discussed example, user 46 may select “band” from within menu 176, resulting in reserve process 10 and/or email client application 22 rendering band selection menu 182. User 46 may select, via onscreen pointer 152, a desired band (e.g., hierarchal position notated as “band 1” through “band 8”) from within band selection menu 182, thereby defining 102 the reserve user group including the users in the selected band.

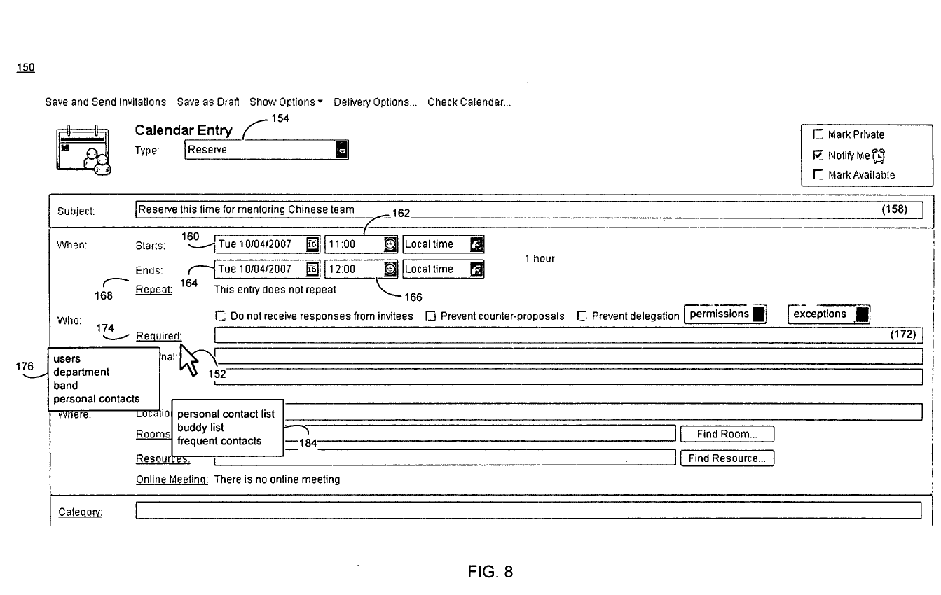

In addition/as an alternative to defining 102 the reserve user group based upon, at least in part, an organizational structure, reserve process 10 may allow a user to define 102 the reserve user group based upon, at least in part, a social network of the user. For example, user 46 may select, via onscreen pointer 152, “personal contacts” option from within menu 176. Referring also to FIG. 8, selecting “personal contacts” option from within menu 176 may result in reserve process 10 and/or email client application 22 rendering menu 184, including “personal contacts list”, “buddy list”, and “frequent contacts”. While menu 184 is only shown including three options, this is for illustrative purposes only, as the number and identity of options within menu 184 may vary to suit various design criteria and user needs.

According to various implementations, selecting “personal contacts list” from within menu 184 may allow user 46 to select one or more users from a personal contacts list, e.g, associated with an email account of user 46. Similarly, selecting “buddy list” from within menu 184 may allow user 46 to select one or more users from an instant messaging buddy list. Further, selecting “frequent contacts” may result in reserve process 10 and/or email client application 22 rendering a listing of frequent contacts (not shown) of user 46. A social network associated with user 46 may arise in a variety of additional/alternative ways (e.g., based upon, at least in part peers, frequent contacts in terms of communications, scheduled meetings, and the like). As such, selection “personal contacts” option from within menu 176 may allow user 46 to define 102 the reserve user group including one or more reserve users based upon a social network of user 46.

In various implementations, the user may define 102 the reserve user group including one or more reserve users in various manners, e.g., which may include combinations of any of the various described examples. For example, the user may define 102 the reserve user group by inputting specific selected users, based upon, at least in part, an organizational structure (e.g., which may include selecting one or more users based upon, at least in part, an organizational hierarchy), and/or based upon, at least in part, a social network of the user. In this regard, the user may iteratively select different options from within menu 176, and may define 102 one or more users of the reserve user group via one or more of the described methodologies. Additionally, various different and/or alternative mechanism and/or interfaces may be implemented for defining 102 the reserve user group including one or more reserve users.

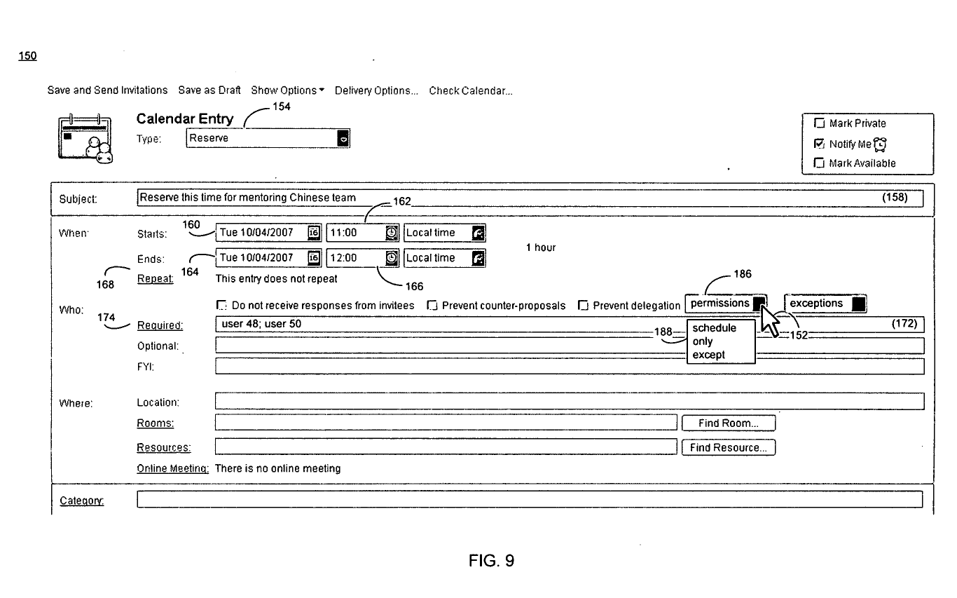

As mentioned above, reserve process 10 may associate 104 the reserve user group, including one or more reserve users, with the defined 100 reserve time period. For example, and referring also to FIG. 9, the one or more reserve users (e.g., user 48 and user 50) may be associated with the defined 100 reserve time period based upon being listed in “Required” field 172.

Reserve process 10 may allow the user to assign 106 scheduling permissions for the reserve time period based upon, at least in part, the associated 104 reserve user group. For example, assigning 106 scheduling permissions may include restricting 110 scheduling permissions for the reserve time period to the reserve user group. In this manner, only the reserve user group may have scheduling permissions to schedule meetings, appointments, events, and the like during the defined 100 reserve time period. For example, user 46 may select, via onscreen pointer 152, permissions drop down 186 resulting in reserve process 10 and/or email client application 22 rendering menu 188 including “schedule”, “only”, and “except”. While menu 188 is only shown including three options, this is only for illustrative purposes, as the number and identity of options within menu 188 may vary according to design criteria and user need.

User 46 may select, via onscreen pointer 152, “schedule” option from within menu 188, resulting in reserve process restricting 110 scheduling permissions for the defined 100 reserve time period to the reserve user group. That is, only the one or more users included in the reserve user group may schedule meetings, appointments, and the like with user 46 during the reserve time period.

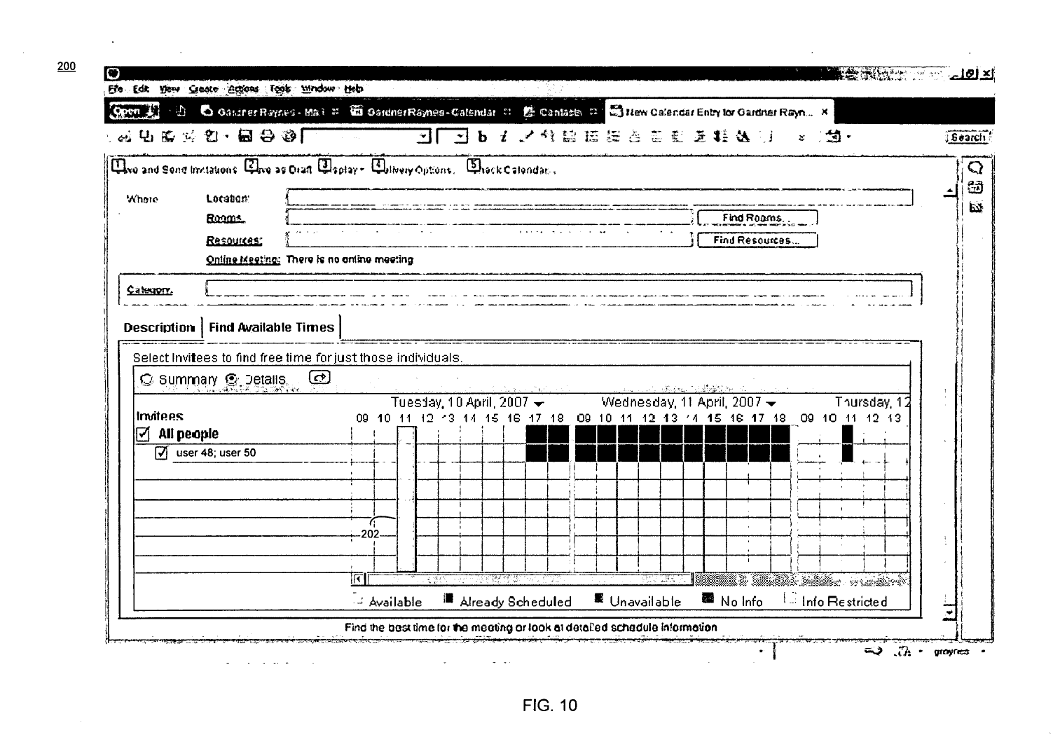

Continuing with the above stated example, and referring also to FIG. 10, email client application 24 may render display screen 200 depicting user 46's availability from the perspective of a reserve user group user (e.g., user 48). Consistent with the assigned 106 scheduling permissions, whereby scheduling permissions for the reserve time period are restricted 110 to the reserve user group, display screen 200 may indicate that reserve time period 202 (e.g., Tuesday, between 11 and 12) is available. As such, user 48 may schedule a meeting, appointment, event, or the like with user 46 during reserve time period 202.

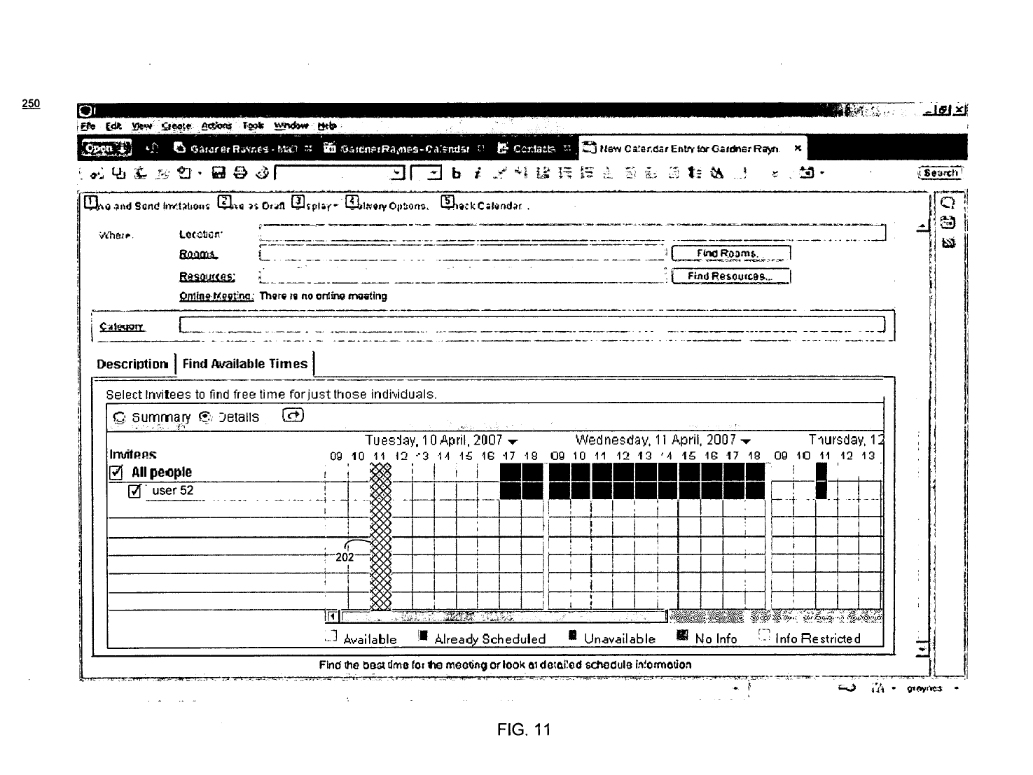

Continuing with the above-stated example, and referring also to FIG. 11, email client application 28 may render display screen 250 depicting user 46's availability from the perspective of a user (e.g., user 52) who is not included in the reserve user group. Consistent with the assigned 102 scheduling permissions, whereby scheduling permissions for the reserve time period are restricted 110 to the reserve user group, the display screen 250 may indicate that reserve time period 202 (e.g., Tuesday, between 11 and 12) is already scheduled, and therefore unavailable. As such, user 52 may not schedule a meeting, appointment, event, or the like with user 46 during reserve time period 202.

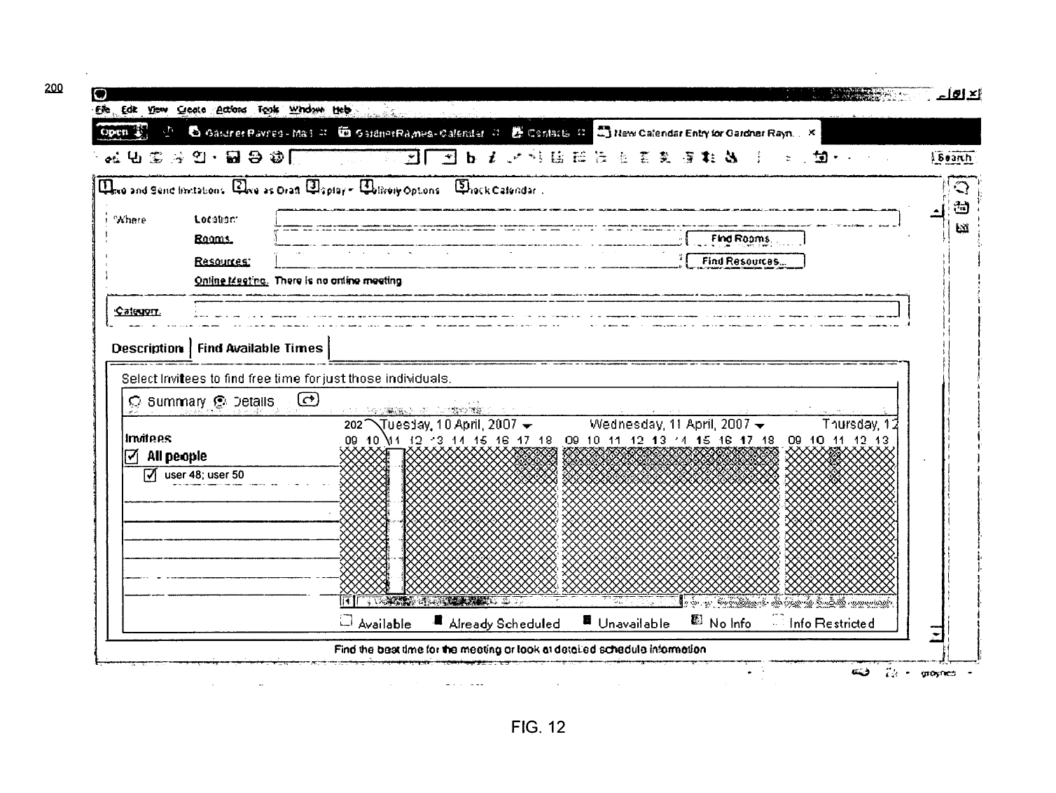

In one implementation, reserve process 10 may allow a user to assign 106 scheduling permissions including restricting 112 scheduling permissions of the reserve user group to the reserve time period. For example, user 46 may select “only” in menu 188 (e.g., referring back to FIG. 9) resulting in reserve process 10 restricting 112 scheduling permissions of the reserve user group to the reserve time period. Continuing with this example, and referring also to FIG. 12, email client application 24 may render display screen 200 depicting user 46's availability from the perspective of user 48 (e.g., a reserve group user). Consistent with the assigned 106 scheduling permissions in which scheduling permissions of the reserve user group are restricted 112 to the reserve time period, reserve timer period 202 (e.g., Tuesday, between 11 and 12) may be indicated as the only available time for user 48 to schedule a meeting, appointment, event, or the like with user 46 (i.e., user 46 is indicated as being unavailable at all other times).

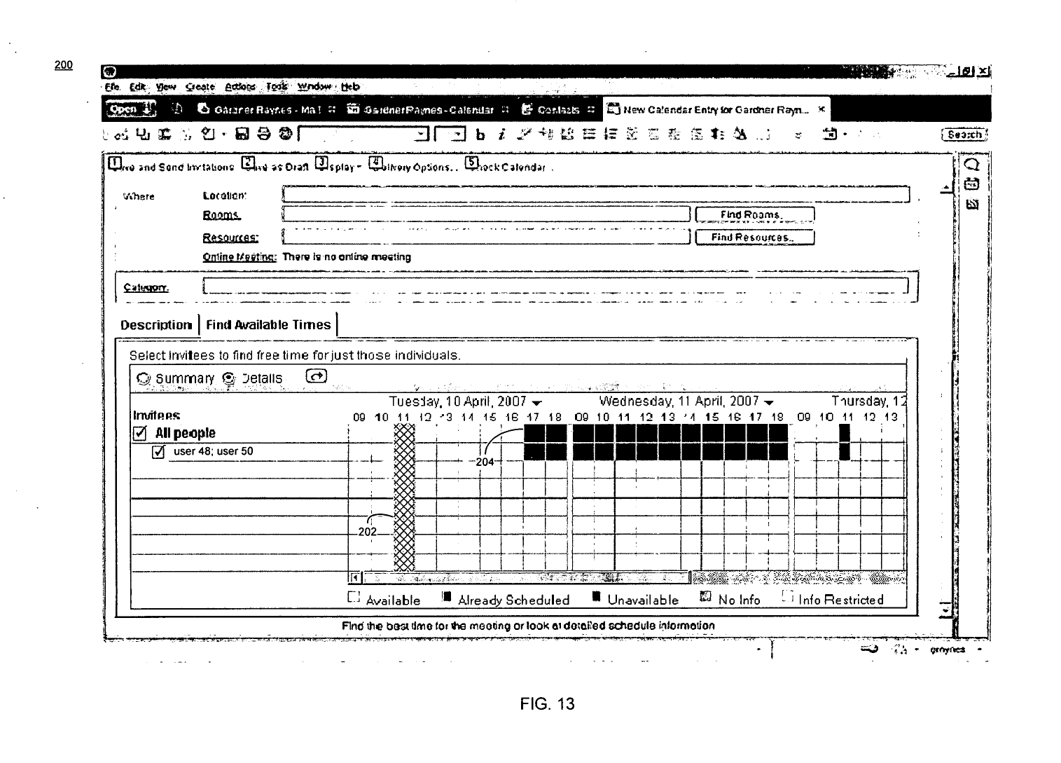

According to another embodiment, reserve process 10 may assign 106 scheduling permissions whereby scheduling permissions of the reserve user group may be restricted 114 for the reserve time period. For example, user 46 may select “except” from within menu 188 (e.g., referring back to FIG. 9) resulting in reserve process 10 restricting 114 scheduling permissions of the reserve user group for the reserve time period. Continuing with this example, and referring also to FIG. 13, email client application 24 may render display screen 200 depicting user 46's availability from the perspective of user 48 (e.g., a reserve group user). Consistent with the assigned 106 scheduling permissions whereby scheduling permissions of the reserve group users are restricted 114 for the reserve time period, user 46 may be indicated as being unavailable for meetings, appointments, events, or the like during reserve time period 202. With the exception of already scheduled meetings (e.g., scheduled meetings 204) user 46 may be indicated as being available for scheduling meetings, appointments, events, or the like at times other than reserve time period 202.

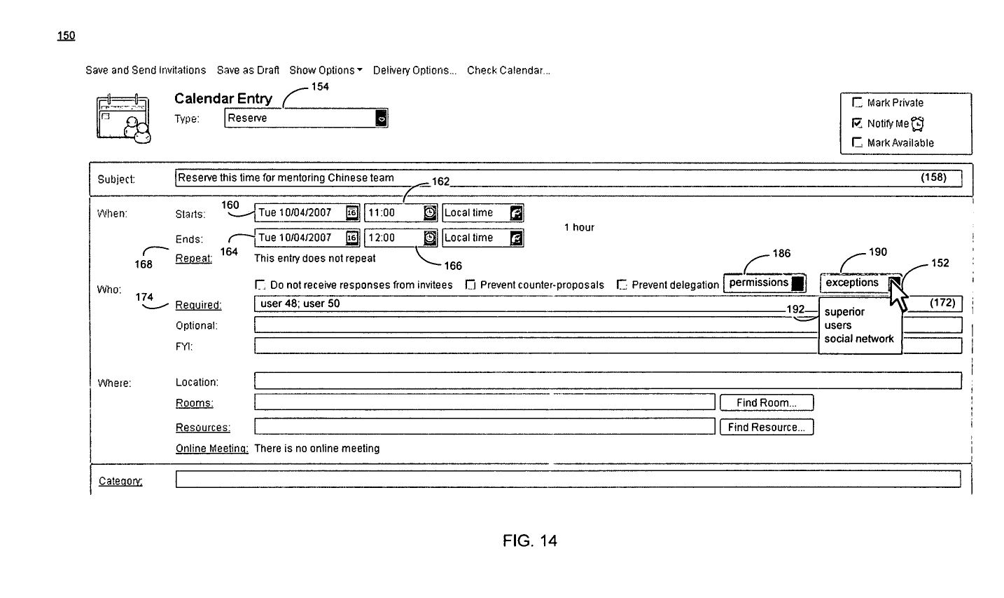

Consistent with one or more of the foregoing examples, reserve process 10 may allow user 46 to define a reserve time period that may be reserved for scheduling appointments by only (or alternatively any user except) a reserve user group including one or more users. Additionally, reserve process 10 may allow a user to define 116 one or more exceptions to the assigned 106 scheduling permissions. For example, and referring also to FIG. 14, user 46 may select, via onscreen pointer 152, exceptions drop down 190, resulting in reserve process 10 and/or email client application 22 rendering menu 192. Menu 192 may include, for example, “superior”, “users”, “social network”. While menu 192 is shown including only three options, this is for illustrative purposes as the number and identity fo the options included within menu 192 may vary according to design criteria and user need. Reserve process 10 may define 116 one or more exceptions to the assigned 106 scheduling permisssions, e.g., based upon options selected from within menu 192.

Continuing with the above-stated example, defining 116 one or more exceptions to the scheduling permissions based upon, at least in part, an organizational structure. For example, user 46 may select, via onscreen pointer 152, “superior” from within menu 192. Selecting “superior” may result in reserve process 10 defining 116 an exception to the assigned 106 scheduling permissions for any user superior to user 46 (e.g., any user having a higher hierarchal position in the organization, as may be abstracted from directory 64). As such, even though a superior user may not be a reserve user, the superior user may nonetheless have scheduling permissions for the reserve time period.

Reserve process 10 may similarly allow user 46 to define 116 one or more exceptions to the assigned 106 scheduling permissions, e.g., allowing one or more non-reserve group users to schedule meetings, appointments, events, or the like relative to the reserve time period, not withstanding the assigned 106 scheduling permissions. For example, user 46 may define 116 exceptions identifying specific users, identifying groups of users (e.g., based upon, at least in part, a social network and/or an organizational structure) and the like. Additionally, reserve process 10 may allow a third party (e.g., a system administrator, a superior, etc.) to define 116 one or more exceptions to the assigned 106 scheduling permissions.

A number of implementations have been described. Nevertheless, it will be understood that various modifications may be made. Accordingly, other implementations are within the scope of the following claims.

What is claimed is:

1. A method comprising:
defining a reserve time period in a scheduling system for a user;
defining a reserve user group including one or more reserve users;
associating the reserve user group with the reserve time period; and
assigning scheduling permissions for the reserve time period based upon, at least in part, the associated reserve user group.

2. The method of claim 1, wherein defining the reserve time period includes defining a recurring reserve time period.

3. The method of claim 1, wherein defining the reserve user group includes defining one or more reserve users based upon, at least in part, an organizational structure.

4. The method of claim 3, wherein defining one or more reserve users based upon, at least in part, an organizational structure includes defining one or more reserve users based upon, at least in part, an organizational hierarchy.

5. The method of claim 1, wherein defining the reserve user group includes defining one or more reserve users based upon, at least in part, a social network.

6. The method of claim 1, wherein assigning scheduling permissions includes restricting scheduling permissions for the reserve time period to the reserve user group.

7. The method of claim 1, wherein assigning scheduling permissions includes restricting scheduling permissions of the reserve user group to the reserve time period.

8. The method of claim 1, wherein assigning scheduling permissions includes restricting scheduling permissions of the reserve user group for the reserve time period.

9. The method of claim 1, further including defining one or more exceptions to the assigned scheduling permissions.

10. The method of claim 9, wherein defining one or more exceptions includes defining one or more exceptions based upon, at least in part, an organizational structure.

11. A computer program product residing on a computer readable medium having a plurality of instructions stored thereon which, when executed by a processor, cause the processor to perform operations comprising:
defining a reserve time period in a scheduling system for a user;
defining a reserve user group including one or more reserve users;
associating the reserve user group with the reserve time period; and
assigning scheduling permissions for the reserve time period based upon, at least in part, the associated reserve user group.

12. The computer program product of claim 11, wherein the instructions for defining the reserve time period include instructions for defining a recurring reserve time period.

13. The computer program product of claim 11, wherein the instructions for defining the reserve user group include instructions for defining one or more reserve users based upon, at least in part, an organizational structure.

14. The computer program product of claim 13, wherein the instructions for defining one or more reserve users based upon, at least in part, an organizational structure, include instructions for defining one or more reserve users based upon, at least in part, an organizational hierarchy.

15. The computer program product of claim 11, wherein the instructions for defining the reserve user group include instructions for identifying one or more reserve users based upon, at least in part, a social network.

16. The computer program product of claim 11, wherein the instructions for assigning scheduling permissions include instructions for restricting scheduling permissions for the reserve time period to the reserve user group.

17. The computer program product of claim 11, wherein the instructions for assigning scheduling permissions include instructions for restricting scheduling permissions of the reserve user group to the reserve time period.

18. The computer program product of claim 11, wherein the instructions for assigning scheduling permissions include instructions for restricting scheduling permissions of the reserve user group for the reserve time period.

19. The computer program product of claim 11, further including instructions for defining one or more exceptions to the assigned scheduling permissions.

20. The computer program product of claim 19, wherein the instructions for defining one or more exceptions include instructions for defining one or more exceptions based upon, at least in part, an organizational structure.
